(19) United States
(12) Patent Application Publication
(10) Pub. No.: US 2015/0183074 A1
(43) Pub. Date: Jul. 2, 2015

(54) APPARATUS, SYSTEM AND METHOD FOR CUTTING A MATERIAL

(71) Applicant: MAKITA CORPORATION, Anjo-shi (JP)

(72) Inventors: Toshiyuki KANI, Anjo-shi (JP); Takaaki KATO, Anjo-shi (JP)

(21) Appl. No.: 14/575,841

(22) Filed: Dec. 18, 2014

(30) Foreign Application Priority Data
Dec. 26, 2013 (JP) 2013-269956

(51) Int. Cl. B23Q 17/24; B23D 47/00; B23D 45/04

(52) U.S. Cl. CPC B23Q 17/2404; B23D 45/042; B23D 47/00

(57) ABSTRACT

An apparatus, method and system for cutting a material involves a cutting device with a body and a base. The body attaches to the base by a swing pivot that swings to position the body. A rotary blade, powered by an electric motor of the cutting device, is associated with the body. The body with the rotary blade may descend upon a table configured to receive the material. The table is mounted on the base beneath the rotary blade. An illumination device that emits light is coupled to a sliding, support portion beneath the swing pivot to direct light toward the rotary blade. Further, a light emitting diode (LED) may be mounted within the illumination device at an angle relative to the body to illuminate the material.

This application claims priority to Japanese patent application Serial Number 2013-269956, filed on Dec. 26, 2013, the disclosure of which is incorporated herein by reference.

### BACKGROUND

1. Field of the Invention

Embodiments disclosed herein relate generally to a cutting device. Specifically, embodiments disclosed herein relate to a device with a table where the device may be adapted to cut and/or slice material placed on the table.

2. Background Art

Currently available mechanized saw assemblies, such as, for example, jig saws, compound saws, slide saws and/or any combination thereof may have an illumination device, such as a light, to illuminate at least a portion of material intended to be cut by the saw. Such illumination of the material may assist and/or facilitate operation of the mechanized saw assembly during low light conditions, such as in nighttime and/or low-light conditions. The following patent documents disclose various techniques relating to the illumination devices associated with mechanized saw assemblies. For example, Japanese Laid-Open Patent Application No. H1-163020 discloses an illumination device, such as a light, located on an arm that supports a main body of a tool, with regard to a table. Also, Japanese Laid-Open Patent Application No. 2002-154074 discloses an illumination device, such as a light, supported by a main body of a tool via a flexible ann.

However, currently available cutting devices, as described above, may fail to adequately address the needs of operators, in for example, cutting material in low-light conditions. For example, Japanese Laid-Open Patent Application No. H1-163020 discloses an illumination device attached to a main body of the cutting device. To operate the cutting device, the main body may be moved and/or depressed to cut and/or slice material. Accordingly, the illumination device moves along with movement of the main body. Such constant and repetitive movement of the illumination device during operation of the cutting device may be undesirable, especially in low-light conditions. Further, the positioning and/or configuration of the illumination device may emit light in a direction generally parallel to the blade of the cutting device, rather than toward the material to be cut.

Moreover, as disclosed in Japanese Laid-Open Patent Application No. 2002-154074, for example, the position of the illumination source must be changed and/or adjusted each and every time the positioning and/or inclination of the tool main body is changed. Thus, handling and/or operation of the cutting device may be cumbersome.

In view of the above, it is desired to improve upon the location and/or placement of an illumination device associated with a cutting device such that the illumination device may be handled and/or adjusted easily, may remain in a fixed position relative to movement of the cutting device and may distribute light uniformly across, for example, both sides of a saw and/or blade of the cutting device.

### SUMMARY

The present invention generally relates to an apparatus, method and system for cutting a material. The apparatus may have a cutting device with a body and a base. The body may attach to the base by a swing pivot that swings to position the body. A rotary blade, powered by an electric motor of the cutting device, may be associated with the body. A table may be mounted on the base beneath the rotary blade and may be configured to receive the material. An illumination device that emits light may be coupled to a sliding support portion beneath the swing pivot to direct light toward the rotary blade at an angle relative to the body.

The illumination device may be associated with author attached to, for example, either side of a sliding support portion of the cutting device. The sliding support portion may be relatively fixed while the body pivots about the swing pivot. Thus, the illumination device may uniformly provide and/or emit a steady stream of light in a direction generally toward the material.

In an embodiment, the apparatus has a light emitting diode (LED) mounted within the illumination device wherein the LED is positioned at an angle relative to the body to illuminate the material.

In an embodiment, the apparatus has a virtual horizontal surface located beneath the body wherein the virtual horizontal surface guides the material into the table and further wherein light emitted from the illumination device illuminates the rotary blade beneath the virtual horizontal surface.

In an embodiment, the apparatus has a plurality of light sources mounted within the illumination device wherein the plurality of light sources are arranged to emit light upon the material.

In an embodiment, the apparatus has a. plurality of light sources mounted within the illumination device wherein a light source of the plurality of light sources emits light in parallel with one or more other lights of the plurality of light sources.

In an embodiment, the apparatus has a transparent and/or translucent case attached to a front side of the illumination device wherein the case is tilted with respect to a direction of the light emitted from the illumination device. Thus, the cover may disperse and/or reduce the intensity of the light emitted by the illumination device to provide a gentle and/or soft light without, for example, a glare, to illuminate a portion of or the entirety of, the material to be cut.

In an embodiment, the apparatus has a fixing lever associated with the cutting device wherein the fixing lever may position the body at a position oblique relative to the base of the cutting device.

In an embodiment, the apparatus has a lock release lever configured to set the table to a rotational position upon the base.

In another embodiment of the present invention, a method for cutting a material by a cutting device is provided. The method has the steps of activating a light source attached to the cutting device to illuminate the material at an angle relative to the body; positioning a material upon a table mounted on top of a base of the cutting device; moving the body with a blade toward the material; and cutting the material with the blade.

In an embodiment, the method further has the step of configuring a light in the light source to emit light toward the material.

In an embodiment, the method further has the step of extending a sliding support portion connected to the body to position the body relative to the table.

In an embodiment, the method further has the step of tightening a lock release lever to set the table to a rotational position.

In an embodiment, the method further has the step of adjusting fixing screws to orient an auxiliary table relative to the table.

In an embodiment, the method further has the step of rotating the blade by a motor associated with the cutting device.

In an embodiment, the method further has the step of directing light from the light source to illuminate the material.

In another embodiment of the present invention, a system for cutting a material is provided. The system has a cutting device with a base positioned beneath a body wherein the body pivots about at an axis of the cutting device. A saw, powered by a motor mounted in the body, may descend toward the base. An illumination device may be fixed in the cutting device beneath the body. A table mounted on the base may configured to receive the material wherein the material is illuminated by light emitted from the illumination device.

In an embodiment, the system has a handle connected to the body wherein the handle is adapted to maneuver the body above a table mounted on the base.

In an embodiment, the system has a sliding member attached to the body wherein the sliding member slides to position the body above the base.

In an embodiment, the system has a plurality of light emitting diodes (LEDs) mounted in the illumination device wherein the LEDs are directed to shine light toward the material.

In an embodiment, the system has a pair of the auxiliary tables configured to be flush with the table to receive the cutting material placed in between the pair of auxiliary tables. Additional features and advantages of the present invention are described in, and will be apparent from, the detailed description, of the presently preferred embodiments and from the drawings.

### BRIEF DESCRIPTION OF THE DRAWINGS

FIG. 1 illustrates a left side view of a cutting device in accordance with an embodiment of the present invention.

FIG. 2 illustrates a right side view of a cutting device in accordance with an embodiment of the present invention.

FIG. 3 illustrates a front view of a cutting device in accordance with an embodiment of the present invention viewed from (III) of FIG 1.

FIG. 4 illustrates a rear view of a cutting device in accordance with an embodiment of the present invention viewed along axis (IV) of FIG. 1.

FIG. 5 illustrates another left side view of a cutting device in accordance with an embodiment of the present invention.

FIG. 6 illustrates another right side view of a cutting device in accordance with an embodiment of the present invention.

FIG. 7 illustrates a top plan view of a cutting device in accordance with an embodiment of the present invention, when viewed from (VII) of FIG. 5.

FIG. S illustrates a front view of a cutting device in accordance with an embodiment Of the present invention where the body is inclined.

FIG. 9 illustrates a back view of a cutting device, in accordance with an embodiment Of the present invention where the body is inclined.

FIG. 10 illustrates a perspective view of a positioning plate and a first movable support plate and a second movable support plate configured for use.

FIG. 11 Illustrates a longitudinal sectional view of a positioning plate from (XI)-(XI) of FIG. 13.

FIG. 12 illustrates a front view of a positioning plate, showing that a first movable support plate and a second movable support plate in position for use.

FIG. 13 illustrates back view of a positioning plate, showing that a first movable support plate and a second movable support plate are positioned to a use position.

FIG. 14 is a front view of a positioning plate, showing that a first movable support plate in a disengaged position.

FIG. 15 illustrates a rear view of a positioning support plate showing a first movable support plate moved to a disengaged position.

FIG. 16 illustrates a front view of a positioning support plate, showing a first movable support plate moved to a retracted position.

FIG. 17 illustrates a rear view of a positioning support plate showing a first support plate moved to a retracted position.

FIG. 18 illustrates a front view of a positioning support plate showing a first movable support plate and a second movable support plate moved to a retracted position.

FIG. 19 illustrates a rear view of a positioning support plate showing a first movable support plate and a second movable support plate moved to a retracted position.

FIG. 20 illustrates a longitudinal sectional view of an illumination device in accordance with an embodiment of the present invention.

### DETAILED DESCRIPTION

In one aspect, embodiments disclosed herein generally relate to a system, method and apparatus for cutting a material. In an embodiment, the material may be a rigid material typically used for and/or associated with construction, such as wood, metal, composite and/or any combination thereof. More specifically, the present invention relates to an apparatus that may use an illumination device associated with a cutting device, where the illumination device may be attached to a swinging support post of the cutting device. The placement and/or location of the illumination device on the swinging support post may allow the illumination device to remain stationary during operation of the cutting device. Accordingly the illumination device may disperse light uniformly across the material to allow for cutting of the material in for example, low light and/or nighttime conditions.

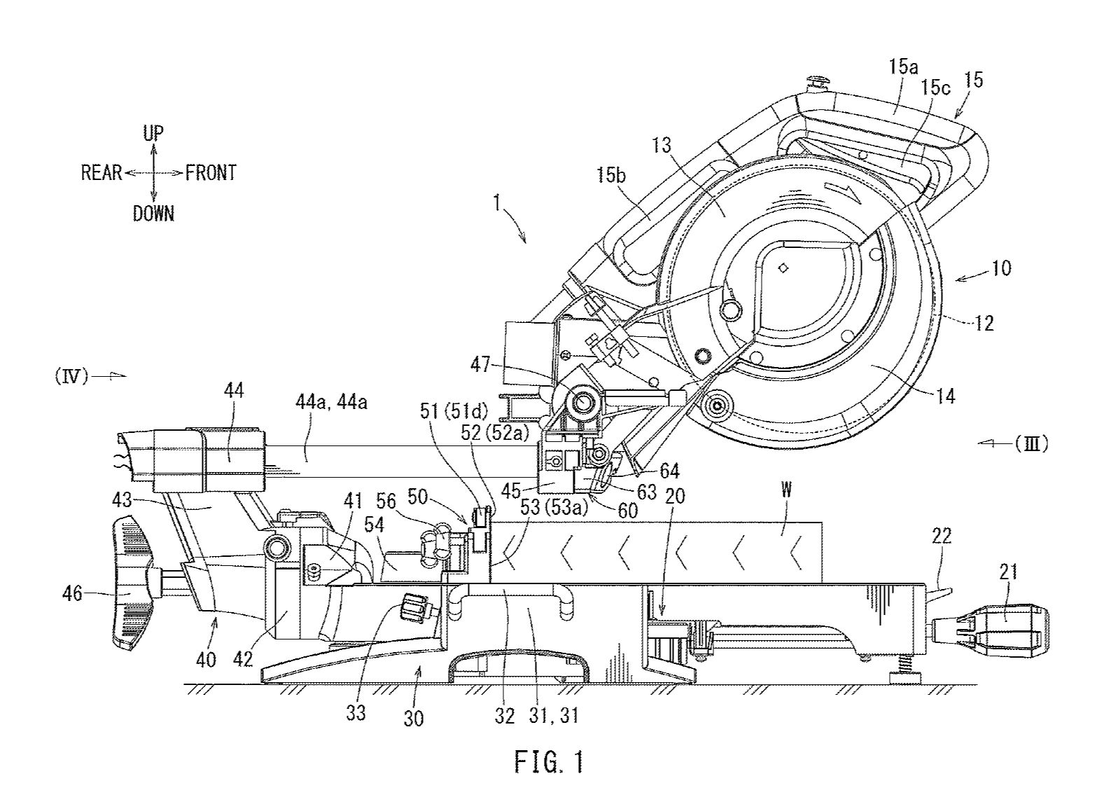

Referring now to the drawings wherein like numerals refer to like parts, FIGS. 1-20 generally illustrate a cutting device 1 in accordance with embodiments of the present invention. In the FIGS., a user may interact with and/or use the cutting device 1 on, for example, either the right or left side of the cutting device 1. Relative orientation terminology used in the description below, such as, for example, a front side, a rear side, a left side, a right side, an upper side, and a lower side with respect to a member and/or a configuration may be based on the position of the user.

As shown in FIGS. 1 to 7, the cutting device 1 may have a table 20 for receiving a cutting material W, a base 30 that may support the table 20, and a body 10. In an embodiment, the table 20 may rotate in the horizontal direction upon the base 30. Also, the body 10 may, for example, swing and/or otherwise move in the vertical direction relative to the base 30. The body 10 may also slide in the horizontal direction, for example, from a front to a rear, via a body supporting member 40 located toward the rear of the table 20.

Two lock mechanisms, such as, for example, lock release levers 21, 22 located near a front of the table 20 may be configured to set the table 20 to a rotational position and/or release the table 20 from the rotational position set earlier. Further, a pair of auxiliary tables 31, 31 may be located on and/or attached to either side, or both sides, of the table 20. An upper surface of the pair of the auxiliary tables 31, 31 may be configured to be flush with an upper surface of the table 20 to accommodate and/or receive the cutting material W which may be placed in between the pair of auxiliary tables 31, 31. Accordingly the cutting material may be placed and/or moved on the table 20 in a stable manner.

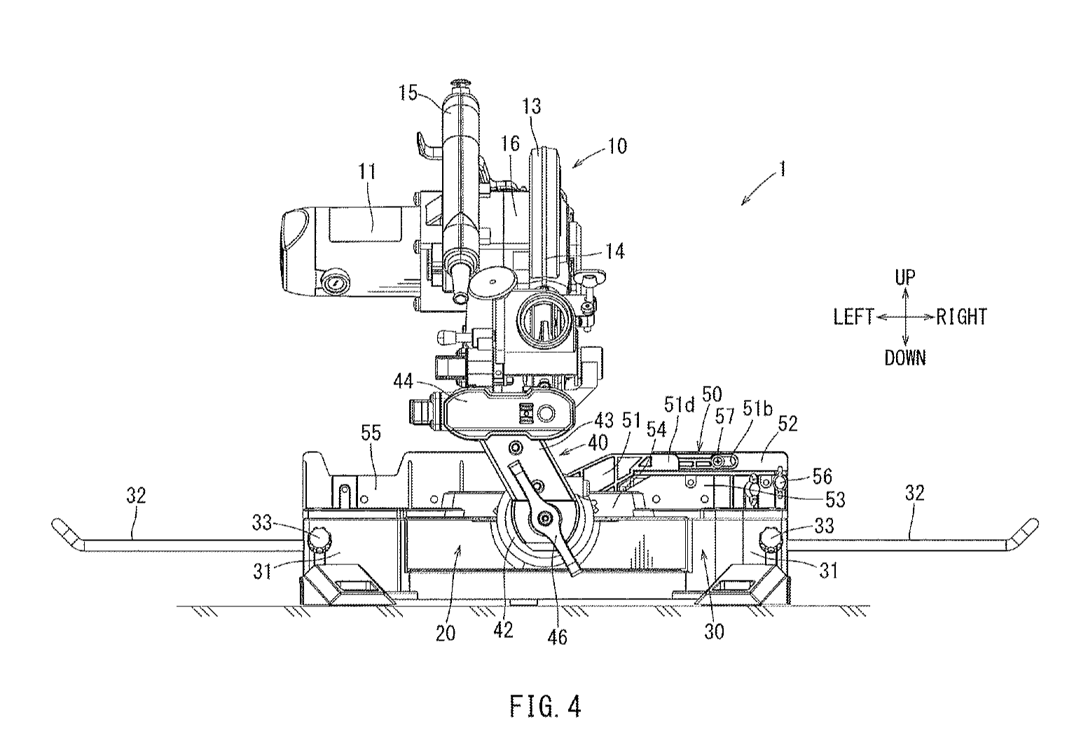

In an embodiment, the pair of the auxiliary tables 31, 31 may be provided with holders 32, 32 that may project outward in, for example, the left and right direction relative to the auxiliary tables 31, 31. Further, tools (riot shown in the FIGS.), such as additional tables for placing a large cutting material W, may be attached to both the holders 32, 32. Both the holders 32, 32 may be removed by loosening fixing screws 33, 33 located in, for example, a rear section of the auxiliary tables 31, 31 as shown in FIG. 4.

Further, a positioning support plate 50 may be located in between the pair of the auxiliary tables 31, 31. The positioning support plate 50 may assist positioning the cutting material W on a surface of the table 20, described in further detail later.

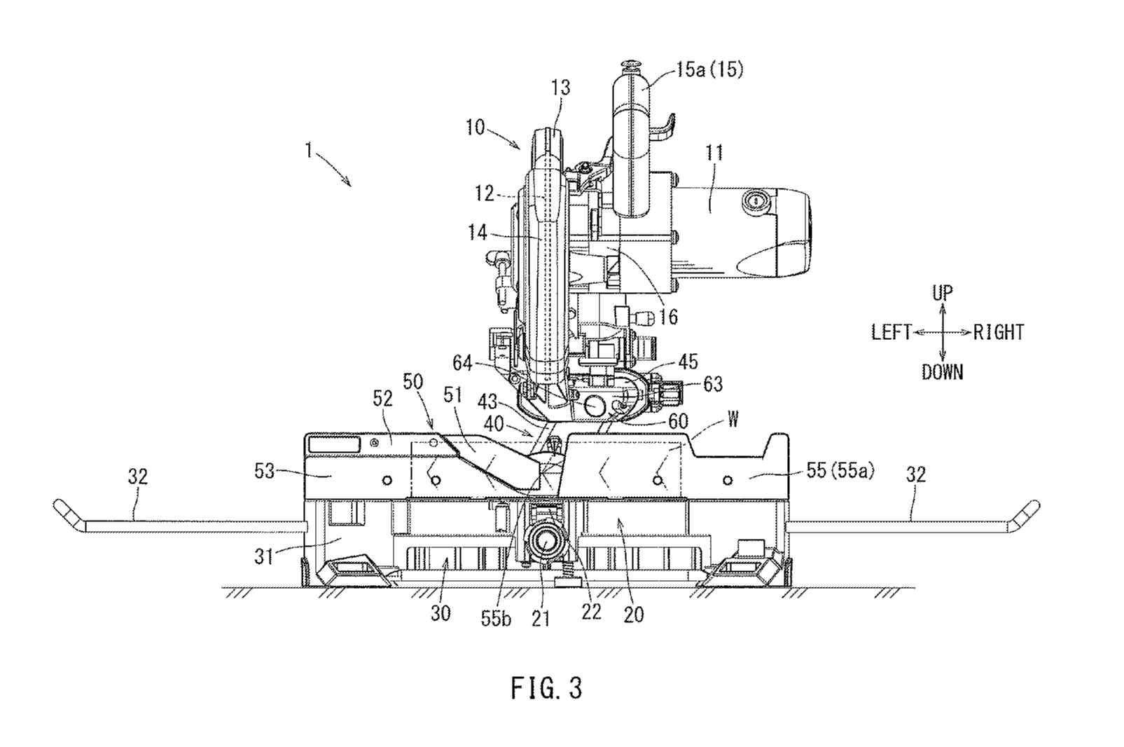

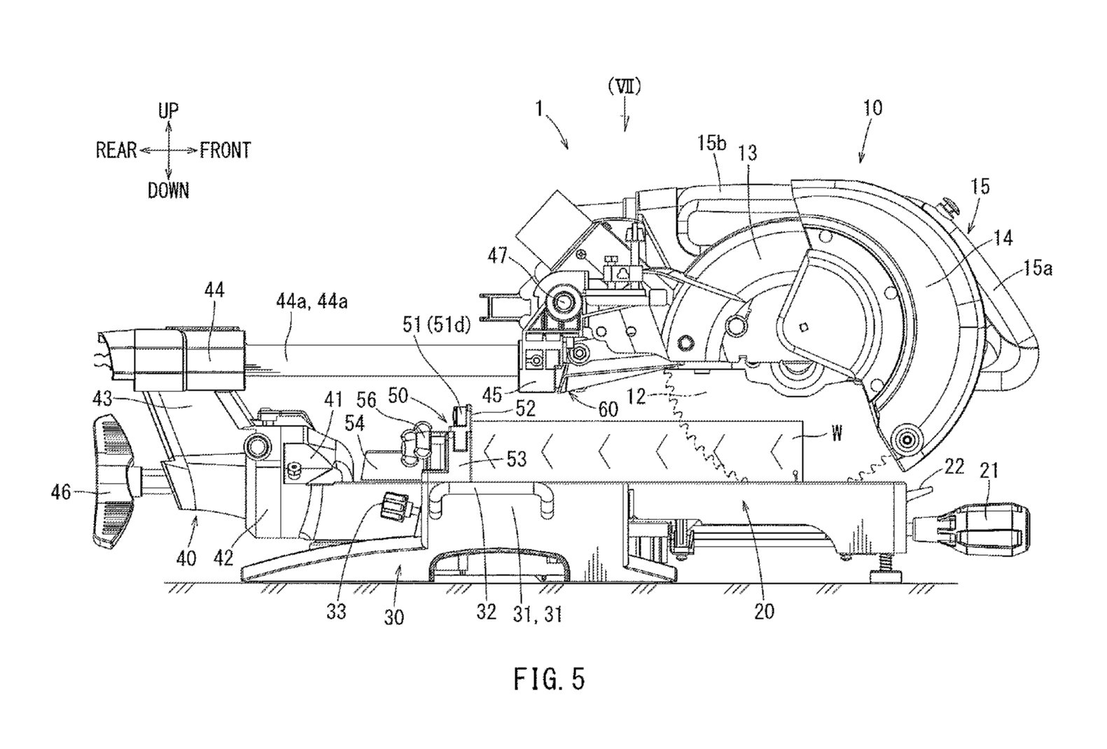

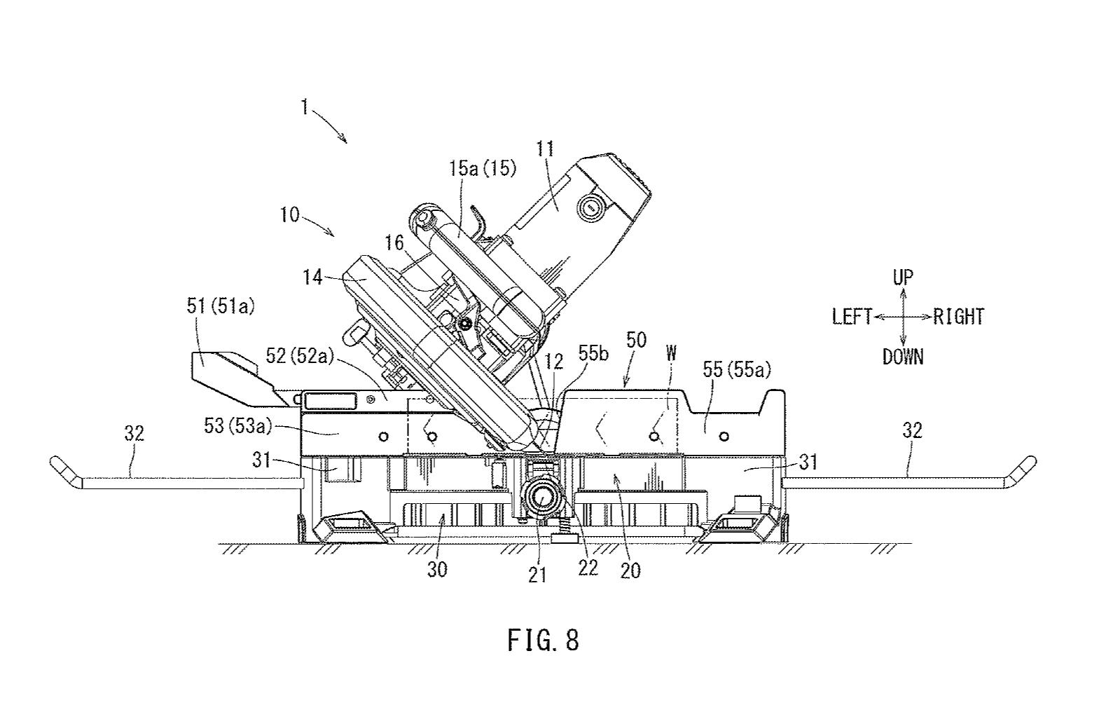

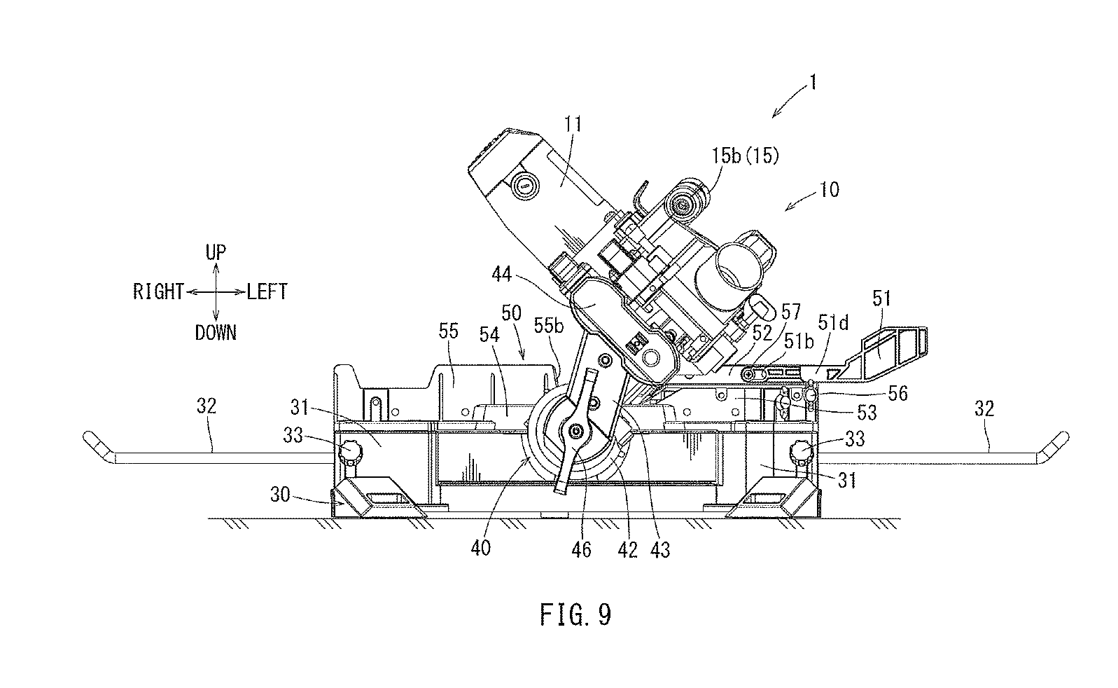

The body supporting member 40 includes a base portion 41 that may be located toward a rear part of the table 20 as shown in FIG. 5. A support portion 42 that may be joined, in, for example, a rotatable manner, to the base portion 41. A supporting arm portion 43 may be integrally formed with and protrude upwards from the support portion 42. A sliding support portion 44 may attach to and/or be associated with an upper part of the supporting arm portion 43. Further, a swinging support portion 45 may extend from an end section of the sliding support portion 44 to, for example, support the body 10 such that the body 10 may move and/or swing in the vertical direction. Each of the base portion 41, the support portion 42 the supporting arm portion 43 and the swinging support portion 45 may incline and/or adjust relative to the table 20 as needed to accommodate insertion and/or placement of the material W on the table 20. Further, a mechanism adapted to adjust the angle and/or inclination between the base portion 41 and the support portion 42, by which the body 10 may be positioned to cut the material W at a perpendicular angle as shown in FIGS. 3 and 4, or may be positioned to cut the material W at an oblique angle, relative to the base 30, as shown, for example, in FIGS. 8 and 9 where the tool main body may be inclined a side by 45 degrees relative to the base 30. A lateral axis of the body 10 may provides a center axis around which the support portion 42 may rotate relative to the base portion 41. The center axis may be located on an upper surface of the table 20 and pass through a center of the table 20. The support portion 42 may be rotated as needed, with regard to the base portion 41, to accommodate, for example, a perpendicular cutting position or an oblique cutting position, as discussed above, for the body 10. Either the perpendicular cutting position, or the oblique cutting position, may be fixed and/or set in place by for example, tightening and/or rotating a fixing lever 46 that may extend from the body supporting member 40 as shown in FIG. 5.

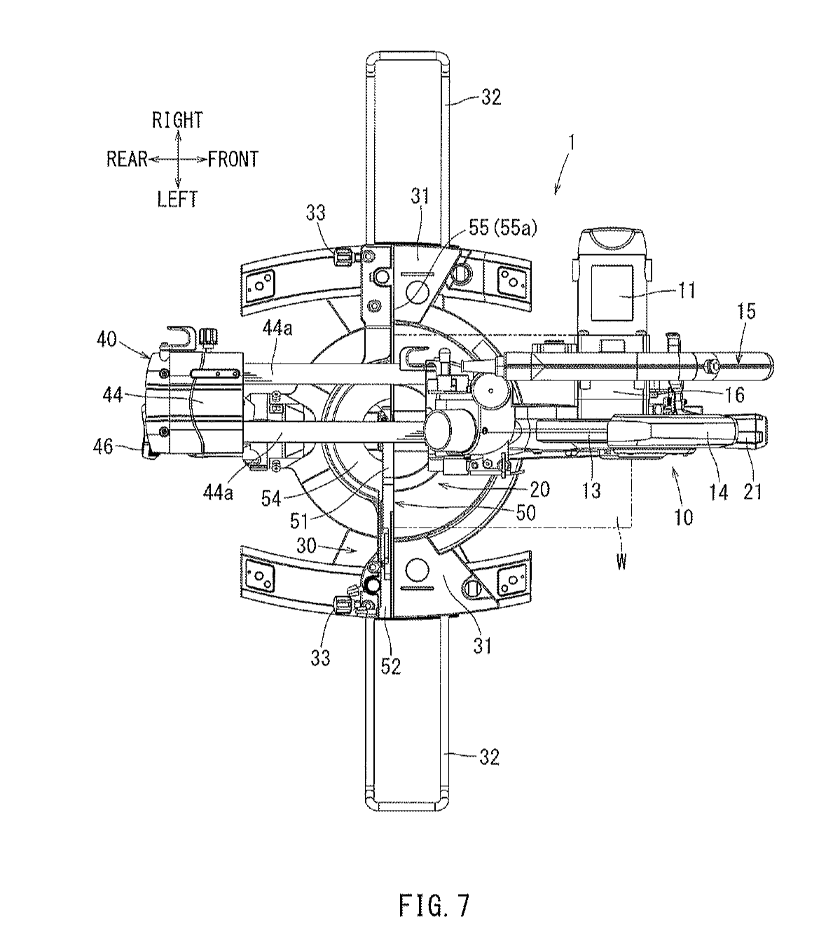

As shown in, for example, FIGS. 5 and 7, the sliding support portion 44 may have a pair of slide bars 44a, 44a, arranged in parallel to each other, where the pair of slide bars 44a, 44a may move and/or slide in a direction, such as from a front to a rear of the table cutting, device 1. The swinging support portion 45 may be attached to an end part of the slide bars 44a, 44a. The body 10 may be supported by the swinging supporting portion 45 through a swinging support axis 47. In an embodiment, the body 10 may swing in a direction, such as the vertical direction and/or an outward or inward direction, around the swinging support axis 47. Accordingly, the body 10 may slidably move in the front-rear direction within, for example, a predetermined length by sliding the slide bars 44a, 44a in the front-rear direction. Further, the body 10 may incline in the vertical direction within a predetermined angle.

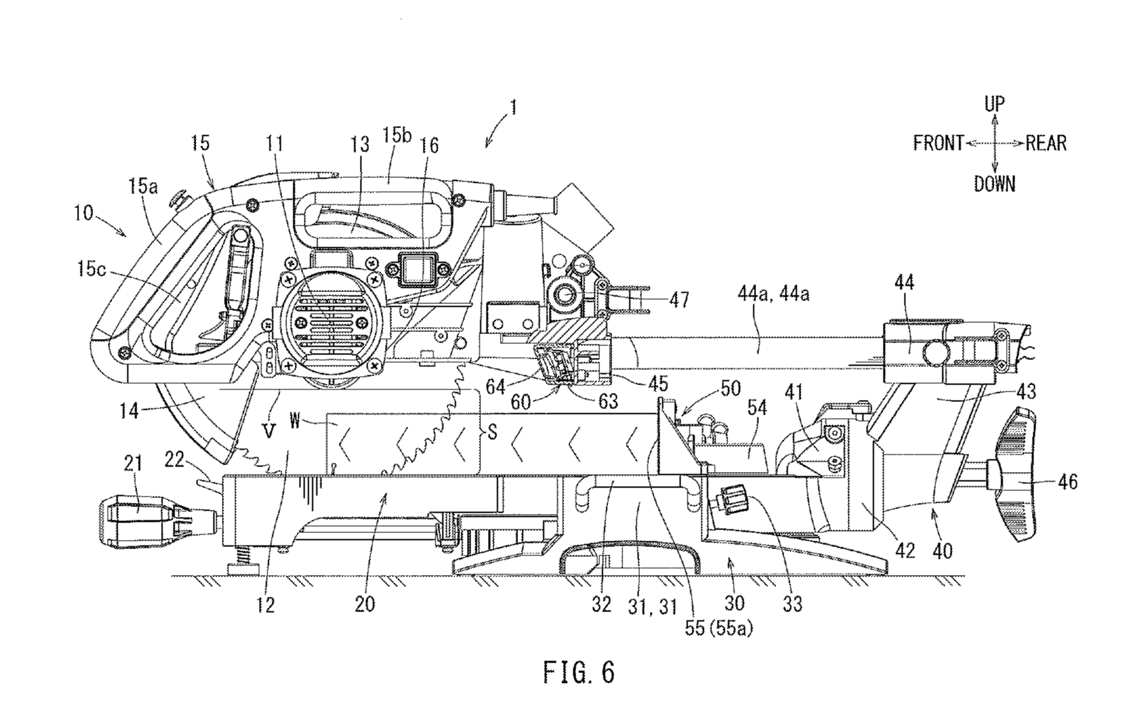

Referring now generally to FIG. 6, the body 10 may have a circular rotary cutting blade 12 that may be rotated by an electric motor 11, a blade case 13 that may cover an upper portion of the rotary cutting blade 12, and a movable cover 14 that can cover a lower portion of the rotary cutting blade 12. A rear part of the blade case 13 may be attached to and/or supported by the swinging support portion 45 via the swinging support axis 47. An electric motor 11 may be attached to a backside (e.g., the right side) of the blade case 13 via a reduction gear portion 16. The reduction gear portion 16 may be provided with a reduction gear train and a gear housing in which the reduction gear train is housed. Rotational energy and/or torque produced by the electric motor 11 may be limited and/or reduced by the reduction gear portion 16 prior to being transmitted to a spindle (not shown in the FIGS.). In an embodiment, the rotary cutting blade 12 may be attached to and/or coupled to the spindle.

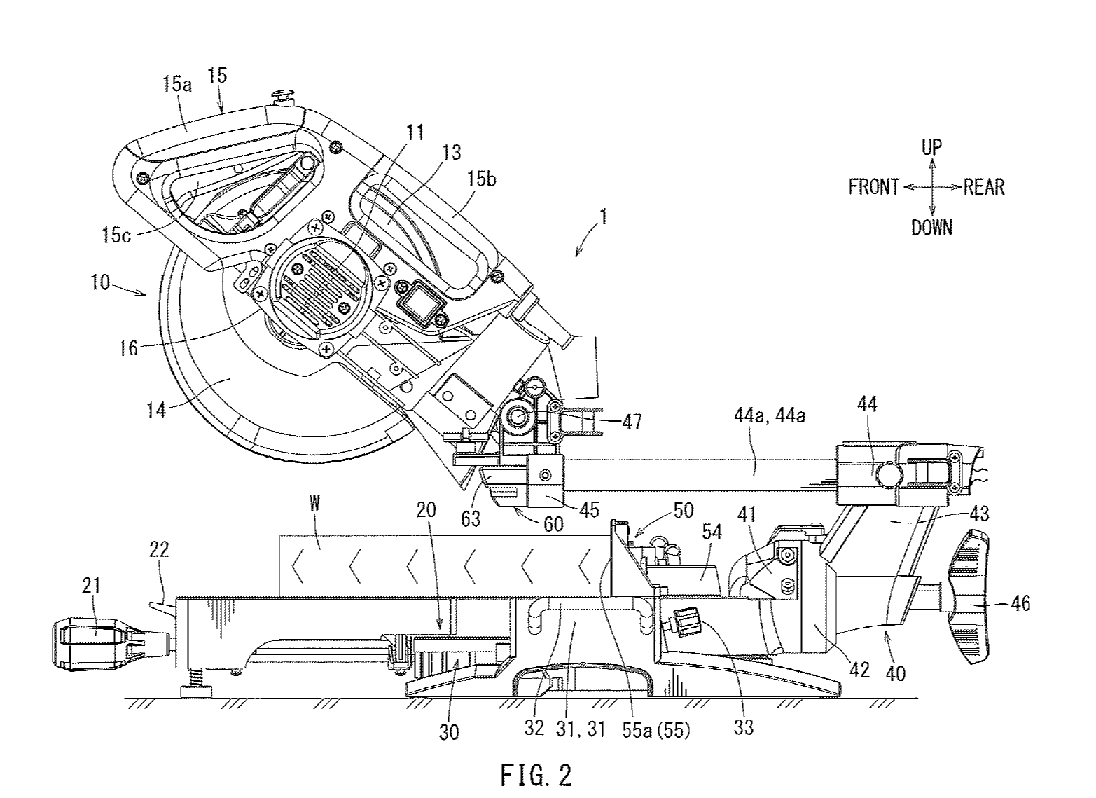

As shown in FIGS. 2 and 6, one or more suction holes may penetrate through the rear surface of the motor housing of the electric motor 11. When the electric motor 11 is started, a cooling fan mounted within the electric motor 11 may be activated and/or rotated. Then, fresh air (e.g., motor cooling air) may be introduced into the motor housing through the suction holes. The introduced motor cooling air may flow into the front side of the motor housing to for example, cool the electric motor to prevent overheating. Further, a controller may be mounted in and/or attached to a rear side of the motor housing for activating and/or controlling the motor. The controller may be cooled by motor cooling an as well as the electric motor 11. A part of the introduced motor cooling air may be redirected and/or exhausted to the outside via exhaust holes located in the front side of the motor housing. The remainder of the motor cooling air may be exhausted into the blade case 13.

A grip and/or a handle 15 may attach to an upper side of the gear housing of the reduction gear portion 16. The handle 15 may have a loop-shaped main handle 15a arranged in the front side of the body 10 and a sub-handle 15b arranged hr the rear side thereof. Further, on the inner circumference side of the main handle 15a, there is arranged a starting switch lever 15c.

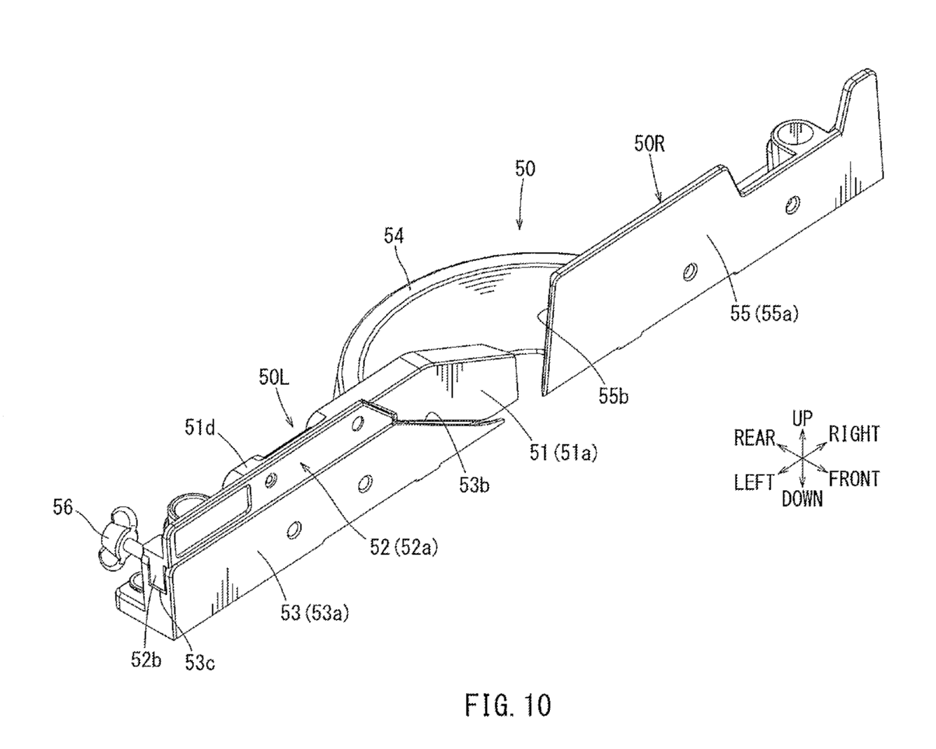

The positioning support plate 50 may be located in and/or near the rear of the table 20. Details of the positioning support plate 50 are shown in FIGS. 10-19. The positioning support plate 50 may have a portion that may be situated on the right side of the rotary cutting blade 12, and a portion that may be situated on the left side thereof. The portions may be identified as either a right side support plate 50R or a left side support plate 50L. The right side support plate 50R may contact and/or abut a fixed divider 55. The left side support plate 50L may have a base portion 53, a first moving member 51, and a second moving member 52. The fixed divider 55 of the right side support plate 50R may be attached and/or connected to the base portion 53 of the left side support plate 50L via a semi-arc-shaped connecting arm portion 54. A front surface of the fixed divider 55 of the right side support plate 50R may he configured as, for example, a positioning surface 55a. The cutting material W may be inserted in and/or positioned in the positioning support plate 50 by contacting a surface of the cutting material W, for example an entire rear surface of the cutting material W, with the positioning surface 55a. The positioning surface 55a may be machined precisely in, for example, a shape with substantially square sides and/or flat surfaces in regard to the upper surface of table 20, as shown in the FIGS.

In an embodiment, the positioning support plate 50 may have distinct features located in the left side support plate 50L. The base portion 53, as shown in for example, FIGS. 9-12, may be fabricated and/or formed to have a relatively lower height than the fixed divider 55 of the right side support plate 50R. A right end portion 53b of the base portion 53 (e.g., an end portion of the rotary cutting blade) may be angled and/or inclined at, for example, an angle greater than 45 degrees. Similarly, a left end portion 55b of the fixed divider 55 of the right side support plate 50R (end portion of the rotary cutting blade) may be inclined at a lesser and/or slight angle (for example, about 10 degrees). Accordingly, the body may incline at an angle on the left side. In an embodiment, the positioning surface 53a of, for example, the entire front surface of the base portion 53 may be configured to position the cutting material W.

The second movable member 52 may be supported along an upper part of the base portion 53. The second movable member 52, which, in an embodiment, may have a greater length than height, and may be slidably supported in the right and left directions. As shown in FIG. 11, a projecting guide portion 52b may project and/or extend along a longitudinal direction in a lower surface of the second movable member 52. The projecting guide portion 52b may be inserted into a guide groove portion 53c that is provided in the upper surface of the base portion 53, and the second movable member 52 is supported slidably in the right and left directions along, for example, an upper part of the base portion 53.

The second movable member 52 may be fixed in a set position by, for example, tightening a screw 56. In an embodiment, the screw 56 may have a knob at one end, as shown in FIG. 11, to assist in tightening the screw 56. In an embodiment, the second movable member 52 may be configured to be the positioning surface 52a as shown in, for example, FIG. 11.

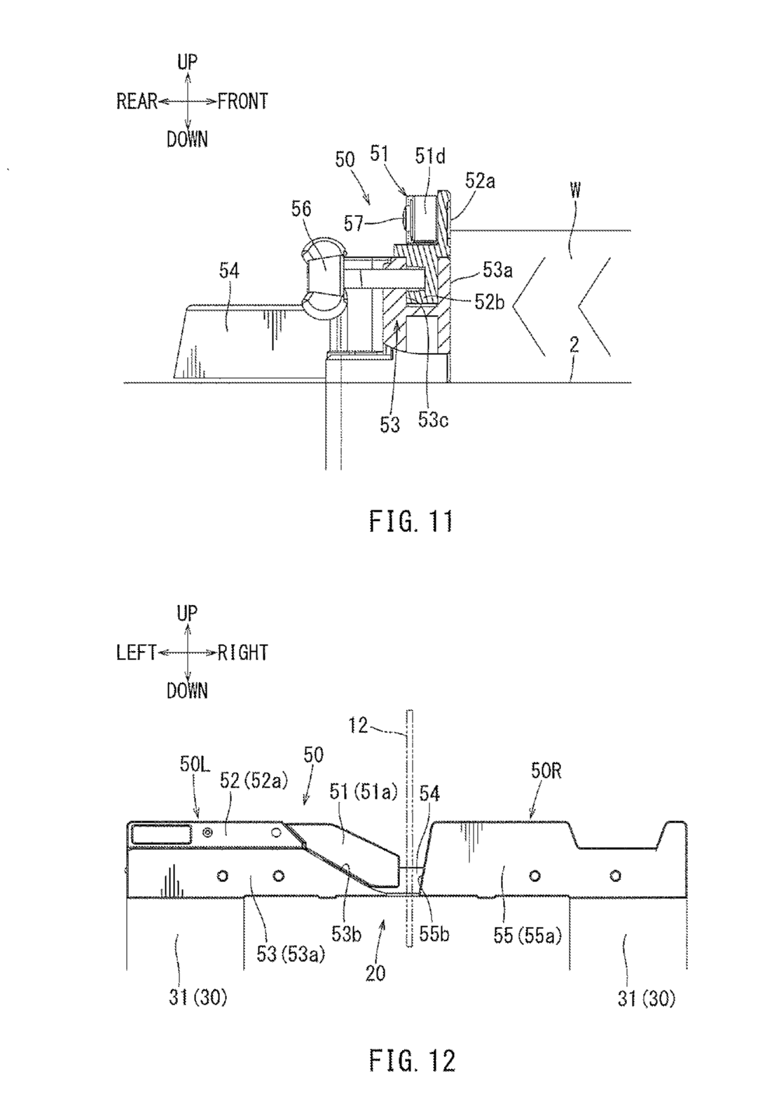

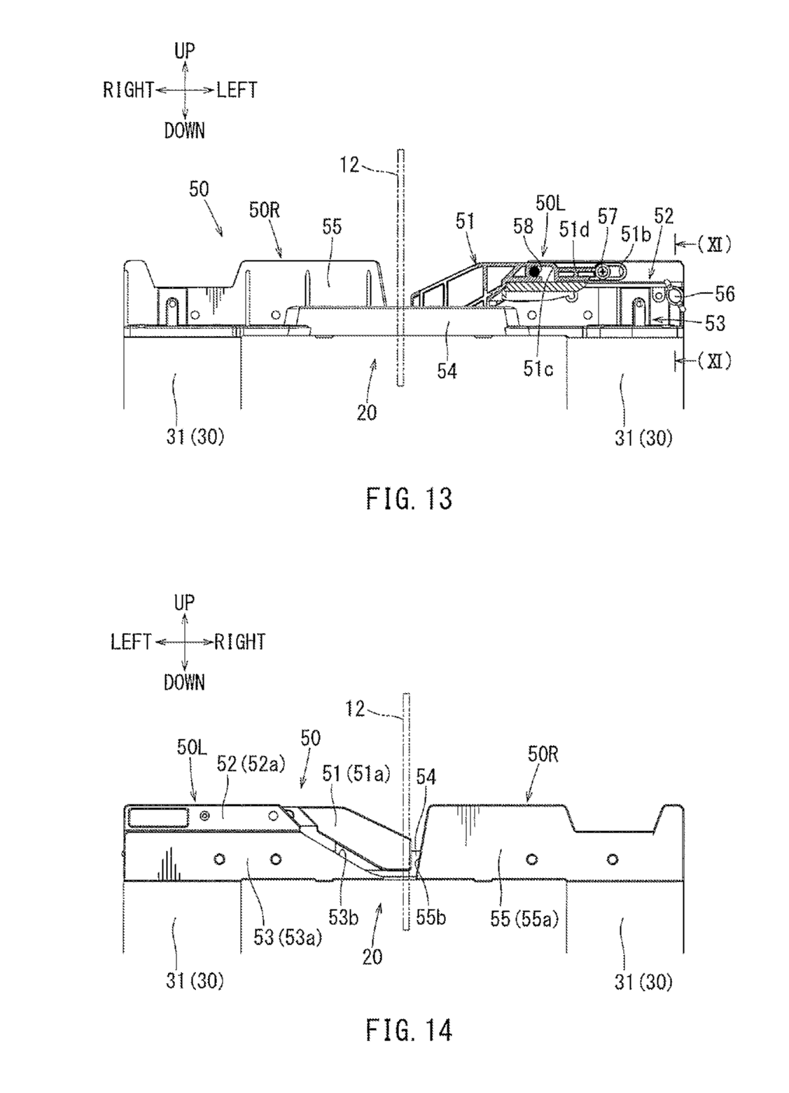

The first moving member 51 may be positioned adjacent to and/or be supported by the second moving member 52. As shown in FIGS. 13, 15, and 17, a supporting arm portion 51d may be affixed to and/or integrally formed with the first moving member 51. The first moving member 51. may be supported by the second movable member 52 via a supporting shaft 57. In an embodiment, the supporting shaft 57 May rotate, as needed, to adjust the position and/or location of the first moving member relative to the second moving member 52. The supporting shaft 57 may be inserted into a supporting hole 51b that may be shaped, for example, as an elongated groove. The supporting hole 51b may be located in a left end part (e.g., a rotary base end portion side) of the supporting arm portion 51d. The first moving member 51 may move, for example, in the right and left directions within a range defined by the supporting shaft 57, e.g. where the supporting shaft 57 may rotate and/or move freely within the supporting hole 51b as shown in, for example, FIG. 13. The first moving member 51 can be moved in, for example, the right, left, forward and/or backward directions between a position suitable for operation as shown in FIGS. 12 and 13 and an release position as shown in FIGS. 14 and 15. As shown in FIGS. 12 and 13, when the first moving member 51 may be positioned in a position suitable for operation and be situated on the right side of the second movable member 52 and/or the base portion 53, the front surface of the first moving member 51 may be parallel and/or flush with the positioning surface 52a of the second movable member 52 and the positioning surface 53a of the base portion 53. In an embodiment, a front surface of the first moving member 51 may be configured as a positioning surface 51a that may be brought into contact with the cutting material W. The positioning surfaces 51a and 52a of the first and second movable members 51 and 52, respectively, and the positioning surface 53a of the base portion 53 may, for example, form a positioning area of substantially the same area as that of the right side support plate 50R as shown in FIG. 10.

Further, the supporting arm portion 51d may be configured vertically so as to remain within an upper portion of the second movable member 52, as shown in, for example, FIGS. 14-16, where the first moving member 51 may be situated in the position suitable for operation, or the engaging release position.

As shown in, for example, FIG. 15, a recess portion 51c may be located at an end side of the supporting arm portion 51d of the first moving member 51, opposite the supporting shaft 57. The engaging recess portion 51c may be formed, for example, in the same direction as the supporting hole 51b. The engaging recess portion 51c may be open on a bottom side as shown in FIGS. 13, 15, and 17. An engaging shaft portion 58 may be located on the rear side of the second movable member 52 in a position adjacent to the engaging recess portion 51c. In an embodiment, the engaging shaft portion 58 may be configured to protrude rearwards In a state where the first moving member 51 is positioned in a position suitable for operation (e.g., the position as shown in FIG. 13) or in a release position (e.g., the position as shown in FIG. 15), the engaging shaft portion 58 may be situated within the engaging recess portion 51c. When the first moving member 51 may be moved to the release position as shown in FIG. 15, the engaging, shaft portion 58 may be moved to an upper side of the opening of the engaging recess portion 51c. While in the release position as shown in FIG. 15, the engaging shaft portion 58 may be pulled out from and/or removed from the opening. Thus, while in the release position, the first moving member 51 may be rotated in a direction, for example, around the engaging shaft portion in the vertical direction.

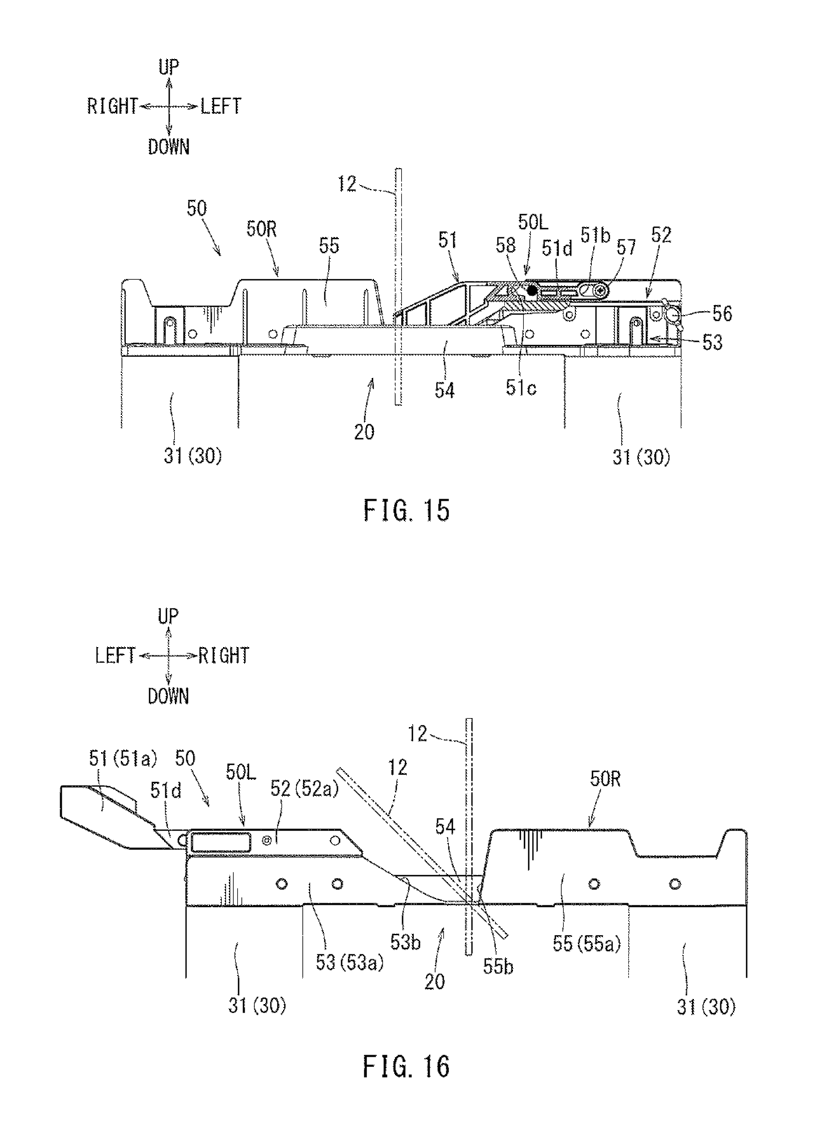

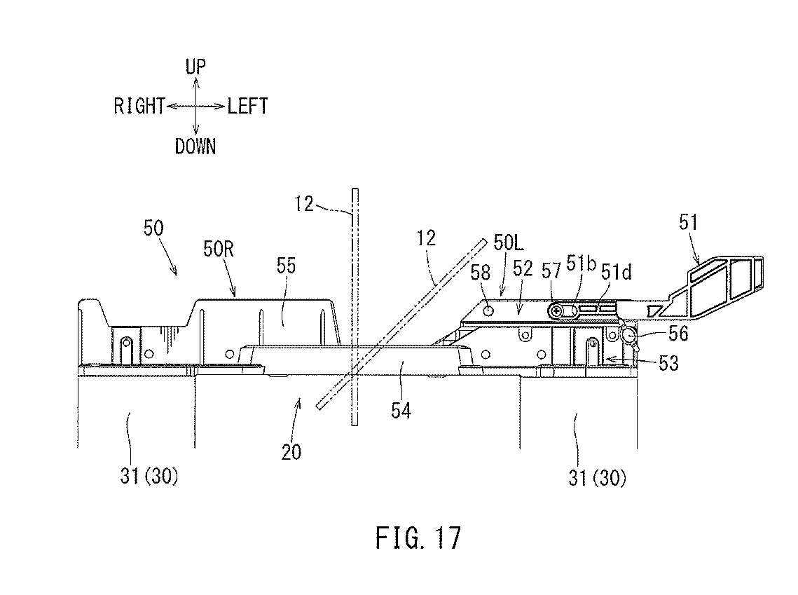

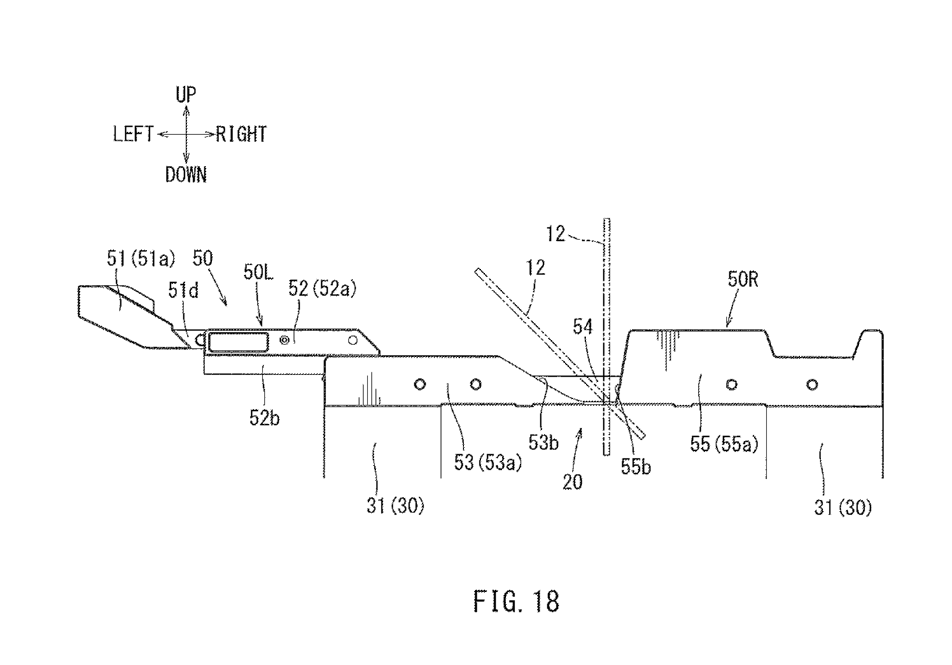

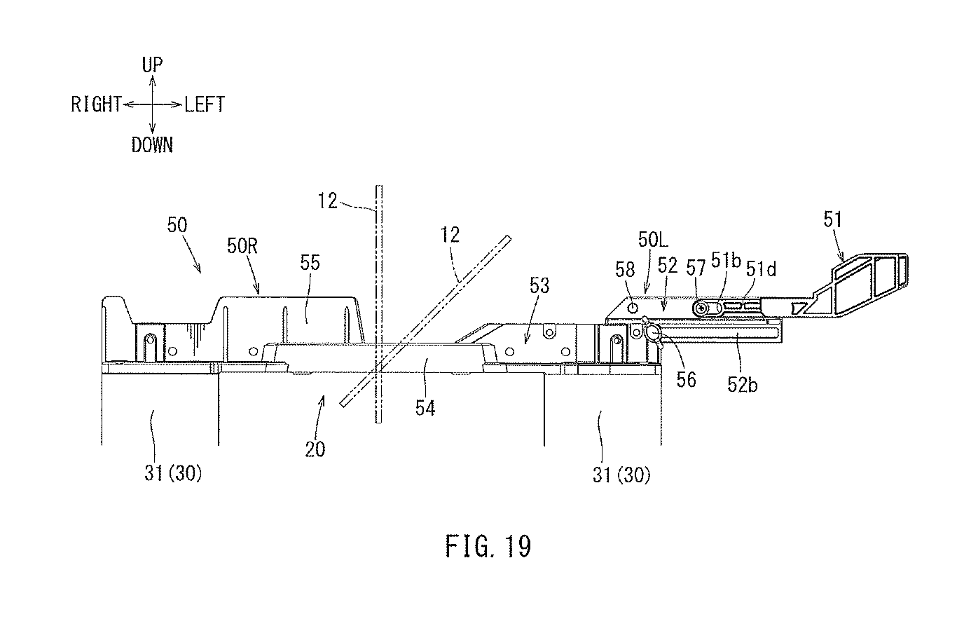

As shown in FIGS. 16 and 17, the first moving member 51 may be moved, transposed and/or inverted to the right and/or left by rotating the first moving member 51 by, for example, 180 degrees around the supporting shaft 57. As shown in FIGS. 18 and 19, by inverting the first moving member 51 to the left side and then loosening the screw 56, the second movable member 52 may be slid toward the left side to a retractable position. By moving the second moving member 52 to the retractable position, the height of the left side support plate 50L, as shown in, for example, FIG. 10, of the positioning support plate 50 may match the height of the base portion as shown in FIGS. 16 and 18.

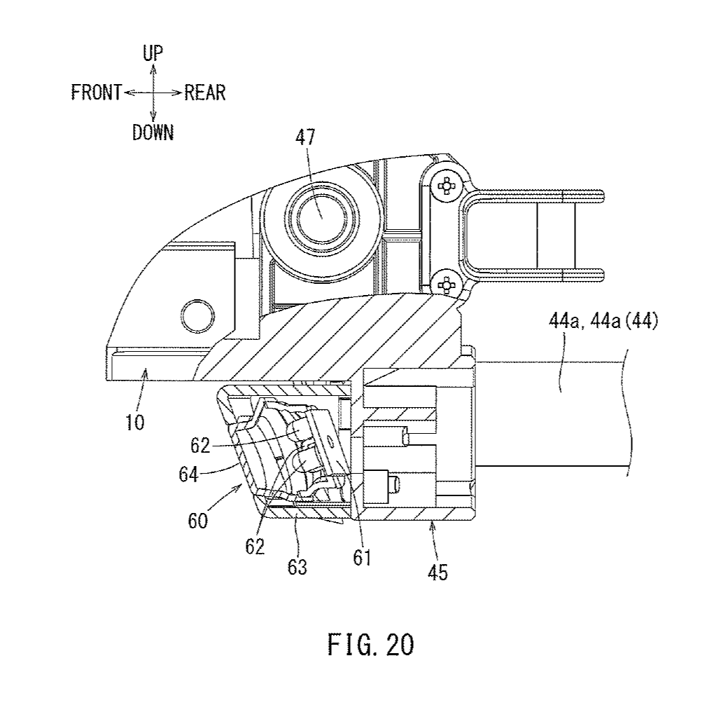

An illumination device 60 may be attached to and/or associated with a front side of the swinging support portion 45, which may support the body 10. In an embodiment, the illumination device 60 may be a lamp, a light, a light emitting diode (LED) and/or any combination thereof adapted to illuminate at least a portion of the material W intended to be cut. Such illumination of the material W may assist and/or facilitate operation of the cutting device 1 during low light conditions, such as nighttime and/or in a dark place. The illumination device 60 is shown in further detail in FIG. 20. As shown in FIG. 20, the illumination device 60 may be coupled and/or attached to the right front side of the swinging support portion 45. More specifically the illumination device 60 may be attached to the right side of the rotary cutting blade 12 when viewed from the front. Further, the illumination device 60 may be located below the swinging support axis 47 (e.g., a swing pivot) of the body 10. The illumination device 60 may illuminate a portion or the entirety, of the material to be cut, or a tip of the rotary cutting blade 12.

As shown in FIG. 20, the illumination device 60 may have up to three LEDs 62 as light sources. The LEDs 62 may be mounted on a control board 61. Further, each LED may be located, for example, on one of areas divided into three in the circumferential direction, and/or the LEDs 62 may be arranged and/or positioned to emit and/or disperse light to, for example, intersect and/or overlap across a common area. Also, the LEDs 62 may be arranged and/or oriented in toward each other, such that each LED of the LEDs 62 may emit light in a direction parallel to the light emitted by the other LEDs 62.

The LEDs 62 may be housed in an illumination case 63. Further, a cover 64 may be attached to a front side of the illumination case 63. In an embodiment, the cover 64 may be transparent and/or translucent. The cover 64 may face toward the front side toward, for example, a user. Also, the cover 64 may point in the downward direction to, for example, better illuminate the cutting material W during operation of the cutting device 1.

As shown in FIG. 20, the LEDs 62 may radiate light in a downward tilting direction when viewed from a side of the cutting device 1. Further, the LEDs 62 may radiate light in, for example, the left-tilted direction viewed from the front. Owing to this, a backside of the controller board 61 can be seen in FIG. 20 (viewed from the right).

As described above, the illumination device 60 may be configured and/or mounted to be offset on, for example the right side with respect to the rotary cutting blade 12. Also, the LEDs 62 may be housed in the illumination case 63 such that the LEDs may emit light in, for example, the downward direction when viewed from the side and in a left-tilted direction viewed from the front. In view of the above, a tip of the rotary cutting blade 12 (a position of the material to be cut) may be effectively illuminated. In an embodiment, when a virtual horizontal surface V that may pass through, for example, a lower end surface of the reduction gear portion 16 of the body 10 may he moved downward to descend as shown in FIG. 6. Accordingly, the illumination direction of the LEDs 62 may be configured such that the LEDs may radiate light toward a blade tip in an area S that may be positioned below the virtual horizontal surface V and above the upper surface of the table 20.

When, for example, the cutting device 1 may be configured as shown in FIG. 6, the illumination device 60 of the present embodiment may illuminate a portion of the material W to be cut to facilitate operation of the cutting device I during low light conditions, such as at night or in a dark place. In an embodiment, the illumination device 60 may be located in front surface of the swinging support portion 45, attached to the body 10, that may move, swing and/or support the body 10 by the front end part of the body supporting member 40. Further, the illumination device 60 may he provided on the from side of the swinging support portion 45 when viewed from a user and on the right side with respect to the rotary cutting blade 12. Further, each LED 62 of the illumination device 60 may be arranged such that each LED may emit light in the downward direction and/or a left-tilted direction.

As described above, the illumination device 60 may be located on a front surface of the swinging support portion 45, near a portion of the material to be cut. Further the illumination device may emit light in, for example, a generally downward and/or tilted direction to illuminate a portion of the material to, for example, prevent casting a shadow of the blade tip to improve general visibility of the material W as needed.

Further, the illumination device 60 may be attached to and/or associated with a front surface of the swinging support portion 45 to emit light to an area on the material W in a direction selected by, for example, a user and/or operator of the cutting device 1.

Moreover, in an embodiment, the illumination device 60 may be attached to a lower side area 5, as shown in FIG. 6, at, for example, a lower end and/or portion of the body 10. As described, the location of the illumination device 60 may allow for uniform and/or unimpeded light dispersion without being blocked by, for example, the body 10. Thus, light emitted from the illumination device 60 may be directed to a tip of the rotary cutting blade 12. Accordingly, a portion, or the entirety, of the material W to be cut may be illuminated as needed.

Further, the illumination device 60 may have up to three light sources, such as each LED, as shown in the FIGS., may be located, for example, on one of areas divided into three in the circumferential direction, and/or the LEDs 62 may be arranged to generally overlap and/or intersect an area and/or circumference on the material W. In an embodiment, each of the LEDs 62 may be positioned to emit light in a direction parallel to light emitted by one or more of the other LEDs. Accordingly, the illumination device 60 may emit light over a generally circular area to, for example, improve visibility of a portion of, or the entirety of, the material W to be cut.

Moreover, and shown in, for example, FIG. 6 and in further detail in FIG. 20, the cover 64 may be transparent and/or translucent and may be tilted with respect to the swinging support portion 45 and/or the lighting direction of the LEDs. The tilt of the cover 64 may allow light emitted from the LEDs 62 to enter and pass through the cover 64 at, for example, an oblique angle relative to the swinging support portion 45 and/or the lighting direction of the LEDs. Additionally, the cover 64 may disperse and/or reduce the intensity of the light emitted by the illumination device 60 to provide a gentle and/or soft light without, for example, a glare, to illuminate a portion of, or the entirety of, the material W to be cut.

The present invention is not limited to the above-described embodiment and may be further modified without departing from the scope and spirit of the present invention. In the above embodiment, the illumination device 60 may be configured to have three LEDs 62. However, one LED, two LEDs, or more than three LEDs may be used as light sources.

Further, in the above embodiment, the illumination device 60 has one or more LEDs 62 used as a light source. However, an electric light bulb may be used, for example, instead of the LED 62, or an electric light bulb may be used with the LED 62. Also, in the above embodiment, each LED may be located, for example, on one of areas divided into three in the circumferential direction, ardor the LEDs 62, and/or the LEDs 62 may be positioned to emit light such that the light may overlap and/or intersect a common area and/or circumference. In addition to that described above, the LEDs may be positioned in other arrangements to achieve different light emission patters as desired.

Such an arrangement of the illumination device 60, as described here, may allow for light emitted from the illumination device to be primarily directed toward illuminating, a portion of or the entirety of the material W to be cut rather than dispersing toward, for example, a user of the cutting device 1. Accordingly, the general visibility of the material W may be improved due to, for example, the positioning and/or configuration of the illumination device 60 and/or the LEDs 62 offset relative to the moving support portion 45.

It should be understood that various changes and modifications to the presently preferred embodiments described herein will be apparent to those skilled in the art. Such changes and modifications may be made without departing from the spirit and scope of the present invention and without diminishing its attendant advantages.

What is claimed is:

1. An apparatus for cutting a material, the apparatus comprising:
a cutting device having a body and a base wherein the body attaches to the base by a swing pivot that swings to position the body;
a rotary blade powered by an electric motor of the cutting device wherein the rotary blade is associated with the body;
a table configured to receive the material wherein the table is mounted on the base beneath the rotary blade; and
an illumination device configured to emit light wherein the illumination device is coupled to a sliding support portion beneath the swing pivot to direct light toward the rotary blade at an angle relative to the body.

2. The apparatus of claim 1, further comprising:
a light emitting diode (LED) mounted within the illumination device wherein the LED is positioned at an angle relative to the body to illuminate the material.

3. The apparatus of claim 1, further comprising:
a virtual horizontal surface located beneath the body wherein the virtual horizontal surface guides the material into the table and further wherein light emitted from the illumination device illuminates the rotary blade beneath the virtual horizontal surface.

4. The apparatus of claim 1, further comprising:
a plurality of light sources mounted within the illumination device wherein the plurality of light sources are arranged to emit light upon the material.

5. The apparatus of claim 1, further comprising:
a plurality of light sources mounted within the illumination device wherein a light source of the plurality of light sources emits light in parallel with one or more other lights of the plurality of light sources.

6. The apparatus of claim 1, further comprising:
a transparent and/or translucent case attached to as front side of the illumination device wherein the case is tilted with respect to a direction of the light emitted from the illumination device.

7. The apparatus of claim 1, further comprising:
a fixing lever associated with the cutting device wherein the fixing lever may position the body at a position oblique relative to the base of the cutting device.

8. The apparatus of claim 1, further comprising:
a lock release lever configured to set the table to a rotational position upon the base.

9. A method for cutting a material by a cutting device, the method comprising:
activating a light source attached to the cutting device to illuminate the material a angle relative to the body;
positioning a material upon a table mounted on top of a base of the cutting device;
moving the body with a blade toward the material; and
cutting the material with the blade.

10. The method of claim 9, further comprising the step of:
configuring a light in the light source to emit light toward the material.

11. The method of claim 9, further comprising, the step of:
extending a sliding support portion connected to the body to position the body relative to the table.

12. The method of claim 9, further comprising the step of:
tightening a lock release lever to set the table to a rotational position.

13. The method of claim 9, further comprising the step of:
adjusting, fixing screws to orient an auxiliary table relative to the table.

14. The method of claim 9, further comprising the step of:
rotating the blade by a motor associated with the cutting device.

15. The method of claim 9, further comprising the step of:
directing light from the light source to illuminate the material.

16. A system for cutting a material, the system comprising:
a cutting device with a base positioned beneath a body wherein the body pivots about at an axis of the cutting device;
a saw powered by a motor mounted in the body;
an illumination device fixed in the cutting device beneath the body at an angle relative to the body; and
a table mounted on the base configured to receive the material wherein the material is illuminated by light emitted from the illumination device.

17. The system of claim 16, further comprising:
a handle connected to the body wherein the handle is adapted to maneuver the body above a table mounted on the base.

18. The system of claim 16, further comprising:
a sliding member attached to the body wherein the sliding member slides to position the body above the base.

19. The system of claim 16, further comprising:
a plurality of light emitting diodes (LEDs) mounted in the illumination device wherein the LEDs are directed to shine light toward the material.

20. The system of claim 16, further comprising:
a pair of the auxiliary tables configured to be flush with the table to receive the cutting material placed in between the pair of auxiliary tables.
